(19) United States
(12) Patent Application Publication
(10) Pub. No.: US 2006/0177606 A1
(43) Pub. Date: Aug. 10, 2006

(54) Polarizing film and producing method thereof, and optical component using the same

(75) Inventors: Yih Hsing Lo, Yilan City (TW); Chun-Hsiung Chen, Dounan Township (TW); De-Hou Liu, Jhuci Township (TW); Yao-Chung Cheng, Taipei City (TW); Liang-Pao Chang, Pingjhen City (TW); Tai-Wang Lai, Pingjhen City (TW); Bor-Ping Wang, Pingjhen City (TW); Shu-Huei Yao, Sanchong City (TW)

Correspondence Address: BUCKNAM AND ARCHER, 1077 NORTHERN BOULEVARD, ROSLYN, NY, 11576, US

(73) Assignee: Optimax Technology Corporation

(21) Appl. No.: 11/149,110

(22) Filed: Jun. 9, 2005

(30) Foreign Application Priority Data
Feb. 4, 2005 (TW) 094103605

(51) Int. Cl. C09K 19/00

(52) U.S. Cl. 428/1.31

(57) ABSTRACT

The present invention provides a polarizing film with high polarization degree and high transmittance, which is directed to the use of polyvinyl alcohol (PVA)-based film by subjecting to a monoaxial multi-step dry-stretch process, thereafter conducting a swelling process in a water-washing tank, cross-dyeing in a dyeing-crosslinking tank comprising an aqueous iodine containing solution, then subjecting to a post stretch process in an stretch tank 05 comprising PVA crosslinking agent, as to obtaining a polarizing film with a transmittance of at least 43% and a polarization degree of at least 98%; and the producing method thereof, a polarizing plate and an optical component produced from the same.

### FIELD OF THE INVENTION

The present invention is directed to a polarizing film useful in liquid crystal display devices and the producing method thereof, particularly to a polarizing film with high polarization degree and high transmittance and the producing method thereof, and a polarizing plate and an optical component produced from the same.

### DESCRIPTION OF THE RELATED PRIOR ART

Liquid crystal display devices have been widely used as display devices for desktop calculators, electronic clocks, personal computers, word processors, televisions, automobiles and machines, wherein polarizing plate and polarizing film are two important components of the liquid crystal display devices.

Conventional polarizing plates were made of polyvinyl alcohol (PVA)-based film (as polarizing film) that dyed iodine or dichromatic dyes on both sides and was oriented, with laminated triacetyl cellulose protective film. The producing method was to use polyvinyl alcohol (PVA) with excellent light transmittance and its derived compounds, by dyeing dichromatic dyes (iodine-based or dye-based and the like) so that iodide ions or dyes diffused into internal layers of polyvinyl alcohol, and subjecting to a stretch process after slightly heating. However, in the case of wet-stretch of polyvinyl alcohol-based film, processing stability can not be obtained since hydrogen bonds are created between water and alcohol group of PVA molecules, which break up hydrogen bonds between PVA molecules, and uneven stretch is made.

Regarding the above problem, a method of producing films with high polarization degree and high transmittance is disclosed in Japanese Patent Laid Open No. Hei 8-240715, wherein a polyvinyl alcohol-based film is subject to a monoaxial dry-stretch process, then dyes iodine and the like and is oriented, thereafter is subject to an immersion treatment in an aqueous boric acid solution at 70-85° C. In addition, an improved method is disclosed in Japanese Patent Laid Open No. Hei 10-288709, wherein a polyvinyl alcohol-based film is subject to a monoaxial dry-stretch process to be dyed, then is extended to 1.5 times or above in boron compound. Further, a method is disclosed in Japanese Patent Laid Open No. Hei 11-49878, wherein a polyvinyl alcohol-based film is subject to a monoaxial dry-stretch process to be dyed, then is extended to 1.1-1.8 times while being immersed in an aqueous boric acid solution. Furthermore, a method is disclosed in Japanese Patent Laid Open No. Hei 14-182035, wherein a polyvinyl alcohol-based film is subject to a monoaxial dry-stretch process, thereafter is released in an aqueous solution containing iodine or dichromatic dyes, and the released film is then extended in an aqueous solution containing PVA crosslinking agent.

In reviewing of the above conventional technical contents, it is not easy to obtain a film of high polarization degree by the method disclosed in Hei 8-240715 patent; potential problem that the film tends to be broken when stretch ratio is increased during the processing in a bath of boron containing compound, in order to enhance polarization degree feature, appears in the methods disclosed in both Hei 10-288709 and 11-49878 patents; a polarizing film with high polarization degree and high transmittance is obtained, though, the promotion of the best optical characteristics is compromised due to the incomplete cleaning out of plasticizer in the polyvinyl alcohol-based film in the method disclosed in Hei 14-182035 patent.

Therefore, a polarizing film with high polarization degree and high transmittance is still extensively expected by those in this field.

### SUMMARY OF THE INVENTION

An object of the present invention is to provide a method for producing a polarizing film.

Another object of the present invention is to provide a polarizing film with high polarization degree and high transmittance.

Still another object of the present invention is to provide a method for using a polarizing plate and an optical component made of the polarizing film.

The present polarizing film is made of polyvinyl alcohol (PVA)-based film by subjecting to a monoaxial multi-step dry-stretch process, thereafter cross-dyeing in a dyeing-crosslinking tank comprising an aqueous iodine containing solution, then subjecting to a stretch process in a stretch tank 05 comprising PVA crosslinking agent. Accordingly, a polarizing film with a transmittance of at least 43% and a polarization degree of at least 98% is obtained.

The present invention discloses a method for producing the polarizing film with high polarization degree and high transmittance, which comprises steps of: subjecting a polyvinyl alcohol (PVA)-based film to a monoaxial multi-step dry-stretch process; washing the extended film to clean plasticizer out in a water-washing tank and to release stress; conducting a cross-dyeing process in an aqueous iodine containing solution and subjecting to a post stretch process in a cross-dyeing tank 04 comprising PVA crosslinking agent.

In the above, when the polyvinyl alcohol (PVA)-based film is subject to a monoaxial multi-step dry-stretch process, firstly it is swelled in a water-washing tank and plasticizer is cleaned out; the stress generated in dry-stretch process is released at this point, film width is reduced and the distance between high molecules is accordingly reduced; then it is cross-dyed in a cross-dyeing tank 04 comprising iodine and PVA crosslinking agent, and the obtained film is subject to a stretch process in a stretch tank 05 comprising PVA crosslinking agent, thus the polarizing film with high polarization degree and high transmittance is obtained to achieve an object of the present invention.

The abovementioned PVA crosslinking agent is selected from at least one compound of the group consisting of boric acid, borax, glyoxal and glutaraldehyde.

The polarizing plate made of the polarizing film according to the invention is characterized in that, it is made by adhering a protective film on at least one side of the polarizing film produced by the present method.

The optical component made of the polarizing film according to the invention is characterized in that, it is made by laminating a reflective plate or a semitransparent reflective plate on the polarizing film produced by the present method. In the above, the optical component is characterized in that, it is made by laminating phase difference plate or input plate on the polarizing film produced by the present method. In the above, the optical component is characterized in that, it is made by laminating optical compensation film. In the above, the optical component is characterized in that, it is made by laminating brightness enhancing film. In the above, the optical component is useful in liquid crystal display devices and is characterized in that, there is a polarizing film produced by the present method on at least one side of the liquid crystal unit.

### BRIEF DESCRIPTION OF THE DRAWING

FIG. 1 is a flow chart showing the method for producing a polarizing film according to the present invention.

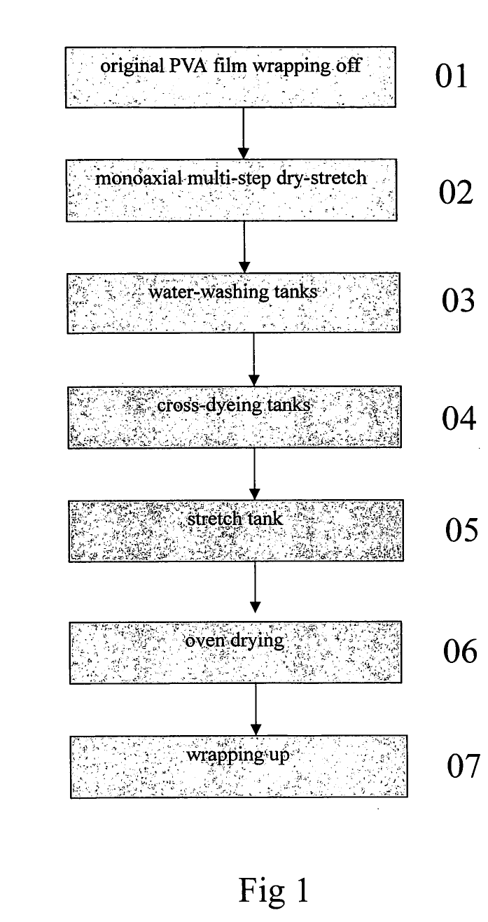

### DESCRIPTION OF SYMBOLS

01 original PVA film wrapping off
02 monoaxial multi-step dry-stretch
03 water-washing tanks
04 cross-dyeing tanks
05 stretch tank
06 oven drying
07 wrapping up

### DETAILED DESCRIPTION OF THE INVENTION

The present invention discloses a method for producing a polarizing film with high polarization degree and high transmittance, which comprises steps of: subjecting a polyvinyl alcohol (PVA)-based film with a polymerization degree of 2,400 to a monoaxial multi-step dry-stretch process; washing the extended film to clean plasticizer out in a water-washing tank and to release stress; conducting cross-dyeing process in a cross-dyeing tank 04 comprising an aqueous iodine solution and subjecting to a wet-stretch process in a cross-dyeing tank 04 comprising PVA crosslinking agent.

The present method is directed to the use of a polyvinyl alcohol (PVA)-based film with a thickness of 5-150 μm in a monoaxial multi-step dry-stretch process, wherein the temperature range is 25-130° C. and the dry-stretch ratio is 1.5 times or above, preferably 2-3 times; and then in a dyeing wet-stretch process, wherein the wet-stretch ratio is 1.5 times or above, preferably 2-3 times, the ratio of wet-stretch to that of dry-stretch is 0.5-1.5, preferably 0.9-1.1, and the total stretch is below 6.5 times, preferably 4.0-6.5 times.

Preferably, the present method is directed to the use of an aqueous iodine containing solution comprising 0.05-10 parts by weight of iodine, 0.05-2.5 parts by weight of PVA corsslinking agent, in terms of 100 parts by weight of water, while controlling the process temperature in a range of 10-80° C.

Preferably, the present method is directed to the use of an stretch tank 05 comprising PVA corsslinking agent, which comprises 0.1-3.5 parts by weight of PVA corsslinking agent, in terms of 100 parts by weight of water, and the temperature range is 25-130° C. PVA corsslinking agent is preferably a boron compound.

### EMBODIMENT

Embodiments and Comparison Examples are given below to concretely describe the technical contents and characteristics of the present invention. However, the present invention is not restricted by thereof.

### Embodiment 1

A polyvinyl alcohol (PVA)-based film with a polymerization degree of 2,400 and a thickness of 75 μm (made by KURARAY, trade name: VF-PS) was monoaxially triple-step extended to 2.5 times in a heating oven at 120° C. Then it was subject to a swelling process in a water-washing tank at 30° C. for 3 minutes, and was cross-dyed in a cross-dyeing bath (concentration: 0.05% by weight) at 33° C. Further, the film was wet-extended to 2.5 times in a stretch tank 05 comprising PVA crosslinking agent, and was immersed for 5 minutes. A polarizing film was obtained after it was dried at 60° C. for 5 minutes.

### Embodiment 2

A polyvinyl alcohol (PVA)-based film with a polymerization degree of 2,400 and a thickness of 75 μm (made by KURARAY, trade name: VF-PS) was monoaxially single-step extended to 2.5 times in a heating oven at 120° C. Then it was subject to a swelling process in a water-washing tank at 30° C. for 3 minutes, and was cross-dyed in a cross-dyeing bath (concentration: 0.05% by weight) at 33° C. Further, the film was wet-extended to 2.5 times in a stretch tank 05 comprising PVA crosslinking agent, and was immersed for 5 minutes. A polarizing film was obtained after it was dried at 60° C. for 5 minutes.

### Embodiment 3

A polyvinyl alcohol (PVA)-based film with a polymerization degree of 2,400 and a thickness of 75 μm (made by KURARAY, trade name: VF-PS) was monoaxially two-step extended to 2.5 times in a heating oven at 120° C. Then it was subject to a swelling process in a water-washing tank at 30° C. for 3 minutes, and was cross-dyed in a cross-dyeing bath (concentration: 0.05% by weight) at 33° C. Further, the film was wet-extended to 2.5 times in a stretch tank 05 comprising PVA crosslinking agent, and was immersed for 5 minutes. A polarizing film was obtained after it was dried at 60° C. for 5 minutes.

### Embodiment 4

A polyvinyl alcohol (PVA)-based film with a polymerization degree of 2,400 and a thickness of 75 μm (made by KURARAY, trade name: VF-PS) was monoaxially triple-step extended to 2.5 times in a heating oven at 120° C. Then it was subject to a swelling process in a water-washing tank at 30° C. for 3 minutes, and was cross-dyed in a cross-dyeing bath (concentration: 0.05% by weight) at 33° C. Further, the film was wet-extended to 2.75 times in a stretch tank 05 comprising PVA crosslinking agent, and was immersed for 5 minutes. A polarizing film was obtained after it was dried at 60° C. for 5 minutes.

### Embodiment 5

A polyvinyl alcohol (PVA)-based film with a polymerization degree of 2,400 and a thickness of 75 μm (made by KURARAY, trade name: VF-PS) was monoaxially triple-step extended to 2.5 times in a heating oven at 120° C. Then it was subject to a swelling process in a water-washing tank at 30° C. for 3 minutes, and was cross-dyed in a cross-dyeing bath (concentration: 0.05% by weight) at 33° C. Further, the film was wet-extended to 2.25 times in a stretch tank 05 comprising PVA crosslinking agent, and was immersed for 5 minutes. A polarizing film was obtained after it was dried at 60° C. for 5 minutes.

### COMPARISON EXAMPLE 1

A polyvinyl alcohol (PVA)-based film with a polymerization degree of 2,400 and a thickness of 75 μm (made by KURARAY, trade name: VF-PS) was monoaxially triple-step extended to 2.5 times in a heating oven at 120° C. Then it was cross-dyed in a cross-dyeing bath (concentration: 0.05% by weight) at 33° C. Further, the film was wet-extended to 2.5 times in a stretch tank 05 comprising PVA crosslinking agent, and was immersed for 5 minutes. A polarizing film was obtained after it was dried at 60° C. for 5 minutes.

### COMPARISON EXAMPLE 2

A polyvinyl alcohol (PVA)-based film with a polymerization degree of 2,400 and a thickness of 75 μm (made by KURARAY, trade name: VF-PS) was monoaxially triple-step extended to 2.5 times in a heating oven at 120° C. Then it was subject to a swelling process in a water-washing tank at 30° C. for 3 minutes, and was dyed in an iodine bath (concentration: 0.05% by weight) at 33° C. Further, the film was wet-extended to 2.5 times in a stretch tank 05 comprising PVA crosslinking agent, and was immersed for 5 minutes. A polarizing film was obtained after it was dried at 60° C. for 5 minutes.

### COMPARISON EXAMPLE 3

A polyvinyl alcohol (PVA)-based film with a polymerization degree of 2,400 and a thickness of 75 μm (made by KURARAY, trade name: VF-PS) was in a water-washing tank at 30° C. for 3 minutes. Then it was cross-dyed in a cross-dyeing bath (concentration: 0.05% by weight) at 33° C. Further, the film was wet-extended to 5 times in a stretch tank 05 comprising PVA crosslinking agent, and was immersed for 5 minutes. A polarizing film was obtained after it was dried at 60° C. for 5 minutes.

Evaluation Test

The following methods were used to evaluate the optical characteristics of the polarizing films made in Embodiments and Comparison Examples. Result is shown in Table 1.

(Transmittance)

The test was run with a spectrophotometer (made by HITACHI) according to J1528701, 2° viewing degree (C light source), to obtain Y value after visibility correction.

(Polarization Degree)

With the above spectrophotometer, transmittances of 2 identical polarizing plates when overlapped in such a manner that polarizing axes were parallel (parallel transmittance: H₀) and polarizing axes were normal (normal transmittance: H₉₀) were measured. Further, parallel transmittance H₀ and normal transmittance H₉₀ were converted into polarization degree Y value (%) after visibility correction according to J1528701, 2° viewing degree (C light source).

$$Polarity ( \% ) = \sqrt{\frac{{H}_{0} - {H}_{90}}{{H}_{0} + {H}_{90}}} \times 100$$

Test Result

It is apparent from Table 1 that, after the polyvinyl alcohol-based film was monoaxially multi-step extended and was swelled in a water-washing tank to clean plasticizer out, the film released stress generated in dry-stretch process and film width was reduced, the distance between high molecules was accordingly reduced; then the film was cross-dyed in a cross-dyeing tank 04 comprising iodine and PVA crosslinking agent, and was subject to a stretch process in a stretch tank 05 comprising PVA crosslinking agent, thus a polarizing film with high polarization degree and high transmittance was obtained.

TABLE 1
Comparison between films made by the present methods in Embodiments
and Comparison Examples

| | | | Film width | Film width |
|---|---|---|---|---|
| | | | before water- | after water- |
| | Transmit- | Polarization | washing tank | washing tank |
| | tance | degree | (mm) | (mm) |
| Embodiment 1 | 43.1 | 99.1 | 500 | 494 |
| Embodiment 2 | 43.2 | 98.9 | 500 | 491 |
| Embodiment 3 | 43.5 | 98.9 | 500 | 490 |
| Embodiment 4 | 43.6 | 98.5 | 500 | 494 |
| Embodiment 5 | 43.2 | 98.1 | 500 | 494 |
| Comparison | 43.1 | 94.2 | 500 | — |
| Example 1 | | | | |
| Comparison | 43.5 | 97.5 | 500 | 494 |
| Example 2 | | | | |
| Comparison | 43.1 | 95.1 | 500 | 607 |
| Example 3 | | | | |

We claim:

1. A method for producing a polarizing film, which comprises at least:
stretching a polyvinyl alcohol (PVA)-based film by using a mono-axial multi-step dry-stretch process;
washing the extended film in water to clean plasticizer out and to release stress;
cross-dyeing the extended film in aqueous iodine containing solution and then applying a post stretch process to the extended film in an aqueous PVA crosslinking agent containing solution.

2. The method as described in claim 1, wherein the post stretch process can be a wet stretch process.

3. The method as described in claim 1, wherein the polymerization of the polyvinyl alcohol (PVA)-based film is 2,400 or above.

4. The method as described in claim 1, wherein the thickness of the polyvinyl alcohol (PVA)-based film is 5-150 μm.

5. The method as described in claim 1, wherein the temperature of the monoaxial multi-step dry-stretch process is 25-130° C., and the stretch ratio is 1.5 times or above, preferably 2-3 times.

6. The method as described in claim 2, wherein the stretch ratio of the dyeing wet-stretch process is 1.5 times or above, preferably 2-3 times.

7. The method as described in claim 2, wherein the ratio of wet-stretch to that of dry-stretch is 0.5-1.5, preferably 0.9-1.1.

8. The method as described in claim 1, wherein the total stretch is below 6.5 times, preferably 4.0-6.5 times.

9. The method as described in claim 1, wherein the PVA crosslinking agent is selected from at least one compound of the group consisting of boric acid, borax, glyoxal and glutaraldehyde.

10. The method as described in claim 1, wherein the aqueous iodine containing solution comprises 0.05-10 parts by weight of iodine and 0.05-2.5 parts by weight of PVA corsslinking agent, in terms of 100 parts by weight of water.

11. The method as described in claim 10, wherein the process temperature is controlled in 10-80° C.

12. The method as described in claim 1, wherein the aqueous PVA corsslinking agent solution comprises 0.1-3.5 parts by weight of PVA corsslinking agent, in terms of 100 parts by weight of water, and the PVA corsslinking agent is preferably a boron compound.

13. The method as described in claim 12, wherein the process temperature is controlled in 25-130° C.

14. A polarizing film produced by the method as described in claim 1, which is a polarizing film with a transmittance of at least 43% and a polarization degree of at least 98%.

15. The polarizing film as described in claim 14, wherein the polarizing plate made therefrom is made by adhering a protective film on at least one side of the polarizing film produced by the present method.

16. The polarizing film as described in claim 14, wherein the optical component made therefrom is made by laminating a reflective plate or a semitransparent reflective plate on the polarizing film produced by the present method.

17. The polarizing film as described in claim 16, wherein the optical component is made by laminating a phase difference plate or an input plate on the polarizing film produced by the present method.

18. The polarizing film as described in claim 16, wherein the optical component is made by laminating an optical compensation film on the polarizing film produced by the present method.

19. The polarizing film as described in claim 16, wherein the optical component is made by laminating a brightness enhancing film on the polarizing film produced by the present method.

20. The polarizing film as described in claim 16, wherein the optical component is made by having the polarizing film produced by the present method on at least one side of a liquid crystal unit of a liquid crystal display device.
